(19) United States
(12) Patent Application Publication
(10) Pub. No.: US 2017/0288515 A1
(43) Pub. Date: Oct. 5, 2017

(54) THREE-DIMENSIONAL SWITCHED RELUCTANCE MOTOR

(71) Applicant: SN Innovation Co., Ltd., Daejeon (KR)

(72) Inventor: Young Chun JEUNG, Downey, CA (US)

(21) Appl. No.: 15/165,665

(22) Filed: May 26, 2016

(30) Foreign Application Priority Data
Mar. 30, 2016 (KR) 10-2016-0038747

(51) Int. Cl. H02K 19/06; H02K 1/24

(52) U.S. Cl. CPC H02K 19/06; H02K 1/246

(57) ABSTRACT

The present invention relates to a three-dimensional (3-D) switched reluctance motor which is configured to minimize a leakage of magnetic flux three-dimensionally formed at a stator core by means of a three-dimensional configuration of a stator pole and a rotor pole, thereby increasing motor efficiency and enhancing output. A rotor core is configured to surround an outer portion of the stator core, while not affecting rotation of the rotor core, including a portion where the stator pole is not previously provided, and the stator pole and the rotor pole extend to the portion, enabling magnetic flux previously leaking through the extended portion of the stator pole and the rotor pole to contribute to reluctance torque.

### CROSS-REFERENCE TO RELATED APPLICATIONS

This patent application claims priority under 35 U.S.C. §119 to Korean Patent Application No. 10-2016-0038747, filed on Mar. 30, 2016, in the Korean Intellectual Property Office, the disclosure of which is incorporated by reference herein in its entirety.

### TECHNICAL FIELD

The present invention relates to a three-dimensional (3-D) switched reluctance motor which is configured to minimize a leakage of magnetic flux three-dimensionally formed at a stator core by means of a three-dimensional configuration of a stator pole and a rotor pole, thereby increasing motor efficiency and enhancing output.

### DISCUSSION OF RELATED ART

A switched reluctance motor (SRM) has a simple configuration in which an excitation coil is wound around a stator. Since torque and output of the switched reluctance motor are determined by a size of current flowing through the excitation coil, the switched reluctance motor is advantageous in that the motor is not affected by a material of a permanent magnet and a size of magnetic flux as compared with other types of motors using a permanent magnet. The switched reluctance motor is easy to manufacture, sturdy and relatively reliable, and competitive in terms of price when compared with other types of motors.

Such SRM is classified into a radial air gap motor, an axial air gap motor, and a transverse flux motor by an air gap direction and a flux path varying depending upon an arrangement of a pole formed, respectively, on a stator and a rotor.

FIG. 1 is a view illustrating a typical SRM classified as a radial air gap motor having an outer rotor.

Referring to FIG. 1, a plurality of stator poles 1a are disposed with equal spacing on an outer circumferential surface of the stator 1 along a circumferential direction and a coil 1b is wound around each of the stator poles 1a to generate magnetic flux in a radial direction. The stator 1 is fixed to an axis hub 3 including a penetration passage of a cylindrical shape at a center position of rotation and stabilized by a stator base 31 supporting the axis hub 3.

The rotor 2 surrounds the outer circumferential surface of the stator 1 with an interval therebetween, and a rotor pole 2a is disposed with equal spacing on an inner circumferential surface of the rotor 2 while facing the stator pole 1a with an air gap therebetween. A rotor housing 4a including a shaft 4 at a center position of rotation is coupled to the axis hub 3 with a bearing interposed therebetween, such that the rotor 2 surrounds the stator 1 and rotates.

Here, upon allowing current to flow through the coil 1b, the stator pole 1a is excited and a magnetic flux F-1 in a radial direction is generated, which leads to reluctance torque to align the rotor pole 2a with the stator pole 1a. As such, a current interruption operation in which current is supplied to the coil 1b when the rotor pole 2a is not aligned with the stator rotor 1a, and current is cut off when the rotor pole 2a is aligned with the stator rotor 1a repeats and rotates the rotor 2.

However, a flux path generated in the stator pole 1a is not only formed in a radial direction F-1 toward the rotor pole 2a, but there also exist leakage paths F-2 and F-3 which do not pass through the rotor pole 2a, resulting in magnetic leakage. Such magnetic leakage causes a loss in torque and output, increases a volume loss of the motor versus output (or reduction in the usage), and reduces life of the bearing 4b, giving rise to corrosion due to electromagnetic reaction resulting from an induced current flowing through, e.g., the shaft 4 or the rotor housing 4a.

A magnetic insulation board blocking the leakage paths F-2 and F-3 can be installed to prevent such magnetic leakage, but the magnetic insulation board causes a motor structure to be complicated and reduces motor efficiency, and despite installation of the magnetic insulation board, the leakage paths are not sufficiently blocked.

FIG. 2 is a cross-sectional side view illustrating a conventional SRM classified as an axial air gap motor.

Referring to FIG. 2, the stator pole 1a is disposed on an upper surface of the stator 1 along a circumferential direction and the rotor pole 2a is disposed on a bottom surface of the rotor 2 along a circumferential direction, such that the rotor pole 2a faces the stator pole 1a in a vertical direction. As a result, magnetic flux generated by the coil 1b wound around the stator pole 1a is formed as an axial flux path F-1.

However, in this case, there exists a leakage path F-2 which does not pass through the rotor pole 2a but is formed toward a side direction, and magnetic leakage takes place.

FIG. 3 is a cross-sectional side view illustrating a conventional SRM classified as a transverse flux motor.

Referring to FIG. 3, the coil 1b is wound around the stator 1 along a circumferential direction. The stator pole 1a divided into an upper stator pole and a lower stator pole with a coil 1b interposed therebetween is disposed along a circumferential direction of the outer circumferential surface of the stator 1. The rotor 2 is provided with the rotor pole 2a along the circumferential direction thereof and the rotor pole 2a facing the stator pole 1a provides a transverse flux path F-1 to the stator pole 1a vertically divided into the upper stator pole and the lower stator pole.

Such a transverse flux motor is advantageous because it is slim, structurally sturdy and reliable in addition to reduced magnetic leakage, but it is still limited in that a leakage path exists in an axial direction F-2 and the magnetic leakage deteriorates motor efficiency.

U. S. Patent Application Publication No. 2010-0295389 discloses an axial flux switched reluctance motor in which a rotor pole 2a is disposed between stator poles 1a vertically separated to thus reduce magnetic leakage. However, magnetic leakage still exists in an outer region of the stator poles 1a and the magnetic flux cannot be efficiently used.

### RELATED ART DOCUMENT

### Patent Document

(Patent 0001) U. S. Patent Application Publication No. 2010-0295389 A1 published on Nov. 25, 2010.

### SUMMARY

The present invention provides a three-dimensional (3-D) switched reluctance motor which is configured to obtain reluctance torque by using a transverse magnetic flux and an axial magnetic flux generated in a stator pole due to an excitation current on a coil.

Embodiments of the present invention provide a 3-D switched reluctance motor which includes a stator core 100 generating one of a radial magnetic flux, an axial magnetic flux, and a transverse magnetic flux, which are generated toward a stator pole 110 excited by a coil 120, and a rotor core 200 rotatably coupled to the stator core 100, including a rotor pole 210 facing the stator pole 110 with an air gap therebetween, and rotating by reluctance torque. The rotor core 200 three-dimensionally surrounds an outer portion of the stator core 100 while not affecting rotation of the rotor, such that a surrounding portion by the rotor core 200 includes a portion in which magnetic leakage occurs. The stator pole 110 and the rotor pole 210 are three-dimensionally formed to extend to the portion in which magnetic leakage occurs and the magnetic flux passing through the extended portions of the stator pole 110 and the rotor pole 210 contributes to the reluctance torque.

The extended portions of the stator pole 110 and the rotor pole 210 are formed to have an arc angle within a range of an are angle of the stator pole 110 and the rotor pole 210 which is set before extending the stator pole 110 and the rotor pole 210, and thus the extended portions of the stator pole 110 and rotor pole 210 are in the same phase.

The stator core 100 includes the stator pole 110 disposed on the outer circumferential surface thereof. The stator pole 110 disposed on the outer circumferential surface vertically divided into an upper portion and a lower portion with respect to the coil 120 wound around the outer circumferential surface along a circumferential direction extends to an upper surface and a lower surface of the stator core 100. The rotor core 200 includes the rotor pole 210 on the inner circumferential surface thereof. The rotor pole 210 disposed on the inner circumferential surface is configured to face the stator core 110 in a radial direction to provide a transverse flux path to the stator pole 110 vertically divided and extends to an inner ceiling surface and a bottom surface thereof, thereby providing an axial flux path to the stator pole 110 extended thereto.

A cross-sectional shape of the stator pole 110 and the rotor pole 210 has multiple step-wise bent portions when the stator pole 110 and the rotor pole 210 are perpendicularly sectioned in an axial direction, and the air gap between the stator pole and the rotor pole has a constant thickness in a whole section.

A cross-sectional shape of the stator pole 110 and the rotor pole 210 has a curved line in a portion of or a whole section when the stator pole 110 and the rotor pole 210 are perpendicularly sectioned in an axial direction, and the air gap between the stator pole and the rotor pole has a constant thickness in each section.

The three-dimensional (3-D) switched reluctance motor according to an exemplary embodiment of the present invention is configured to surround the stator core by the rotor core, while not affecting rotation of the rotor, and three-dimensionally form the stator pole and the rotor pole to minimize magnetic flux leakage three-dimensionally generated in the stator core and to thus contribute to reluctance torque, thereby increasing motor efficiency and output.

### BRIEF DESCRIPTION OF THE DRAWINGS

A more complete appreciation of the present invention and many of the attendant aspects thereof will be readily obtained as the same becomes better understood by reference to the following detailed description when considered in connection with the accompanying drawings, wherein:

FIGS. 1A and 1B, respectively, are a cross-sectional top view and a cross-sectional side view illustrating a conventional switched reluctance motor (SRM) classified as a radial air gap motor;

FIG. 2 is a cross-sectional side view illustrating a conventional SRM classified as an axial air gap motor;

FIG. 3 is a cross-sectional side view illustrating a conventional switched reluctance motor classified as a transverse flux motor;

FIG. 4 is a perspective view illustrating a three-dimensional (3-D) switched reluctance motor according to a first embodiment of the present invention;

FIG. 5 is a cross-sectional side view illustrating a 3-D switched reluctance motor according to a first embodiment of the present invention;

FIG. 6 is an exploded perspective view illustrating a 3-D switched reluctance motor according to a first embodiment of the present invention;

FIG. 7 is an enlarged perspective view illustrating a stator core 100 and a rotor core 200 of FIG. 6;

FIG. 8 is a perspective view illustrating a three-dimensional (3-D) switched reluctance motor according to a second embodiment of the present invention;

FIG. 9 is a cross-sectional side view illustrating a 3-D switched reluctance motor according to a second embodiment of the present invention;

FIG. 10 is an exploded perspective view illustrating a 3-D switched reluctance motor according to a second embodiment of the present invention;

FIG. 11 is an enlarged perspective view illustrating a stator core 100 and a rotor core 200 of FIG. 10;

FIG. 12 is a cross-sectional view illustrating a multi-phase 3-D switched reluctance motor assembled in a serial form according to a third embodiment of the present invention;

FIG. 13 is a view illustrating a rotation angle of a rotor pole 210 at each unit module displayed on a cross-sectional top view of a unit module;

FIG. 14 is a perspective view illustrating a multi-phase 3-D switched reluctance motor assembled in a parallel form according to a fourth embodiment of the present invention;

FIG. 15 is a view illustrating a gear in dotted lines displayed on a cross-sectional top view of FIG. 14;

FIG. 16 is a cross-sectional side view illustrating a 3-D switched reluctance motor according to a fifth embodiment of the present invention;

FIG. 17 is a cross-sectional side view illustrating a 3-D switched reluctance motor according to a sixth embodiment of the present invention;

FIG. 18 is a cross-sectional side view illustrating a 3-D switched reluctance motor according to a seventh embodiment of the present invention; and

FIG. 19 is a cross-sectional side view illustrating a 3-D switched reluctance motor according to an eighth embodiment of the present invention.

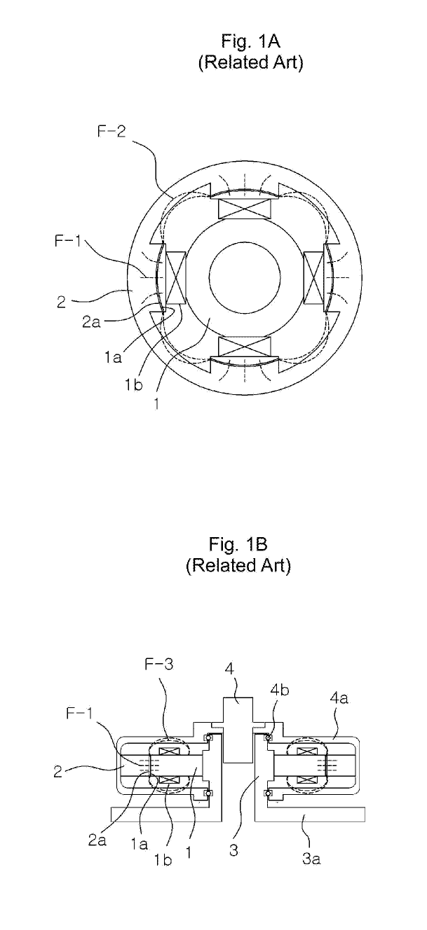

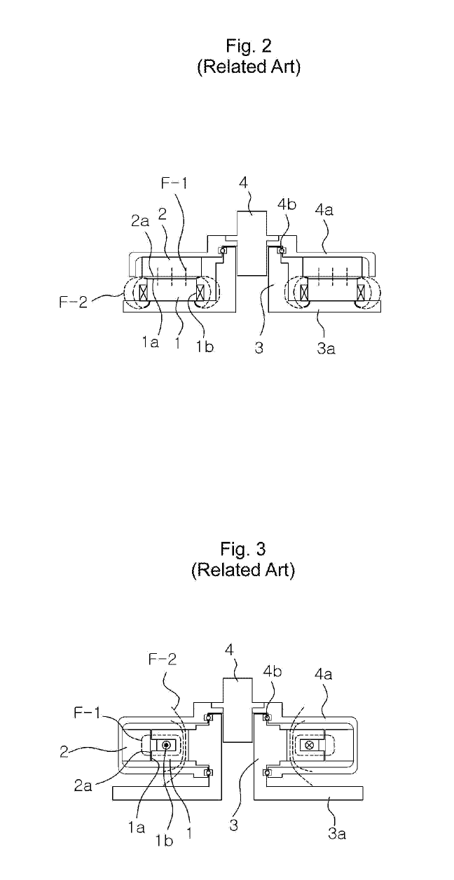

### DETAILED DESCRIPTION OF EXEMPLARY EMBODIMENTS

Hereinafter, preferred embodiments of the present invention will be described in detail with reference to the accompanying drawings to allow a person of ordinary skill in the art to practice the present invention.

A typical switched reluctance motor (SRM) includes a plurality of stator poles 110 excited by a coil 120 and distributed with equal spacing along a circumferential direction, a stator core 100 supported by a supporting member (stator mount portion) placed at a position where the motor is used, a rotor pole 200 facing the stator pole 110 with an air gap therebetween and distributed with spacing along a circumferential direction, and a rotor core 200 rotatably coupled to the stator core 100. Depending upon an arrangement of the stator pole 110 and the rotor pole 210, one of a radial magnetic flux, an axial magnetic flux, and a transverse magnetic flux is enabled to pass through the air gap. Accordingly, reluctance torque to align the stator pole and the rotor pole with each other upon exciting the stator pole 110 rotates the rotor core 200.

In a conventional SRM, one of the radial magnetic flux, the axial magnetic flux, and the transverse magnetic flux generates torque. According to an embodiment of the present invention, however the rotor core 200 is configured to three-dimensionally surround an outer surface of the stator core 100, while not affecting rotation of the rotor, including additional portions in which the stator pole 110 is not formed and thus magnetic leakage occurs.

For example, the rotor core 200 surrounds the stator core 100 except a portion where the supporting member is seated, as long as the rotor core 200 is not prevented from rotating upon rotating the rotor core 200.

Further, the stator pole 110 is formed to extend to the additionally surrounding portion by the rotor core 200 and similarly the rotor pole 210 is formed to extend thereto, such that the stator pole 110 and the rotor pole 210 are three-dimensionally formed having an air gap therebetween in which magnetic flux is intensively generated. Thus, magnetic flux previously leaking from the extended portions contributes to reluctance torque.

Exemplary embodiments of the present invention are provided below, in which the aforementioned description is applied to a transverse flux motor having an outer rotor.

### A First Embodiment

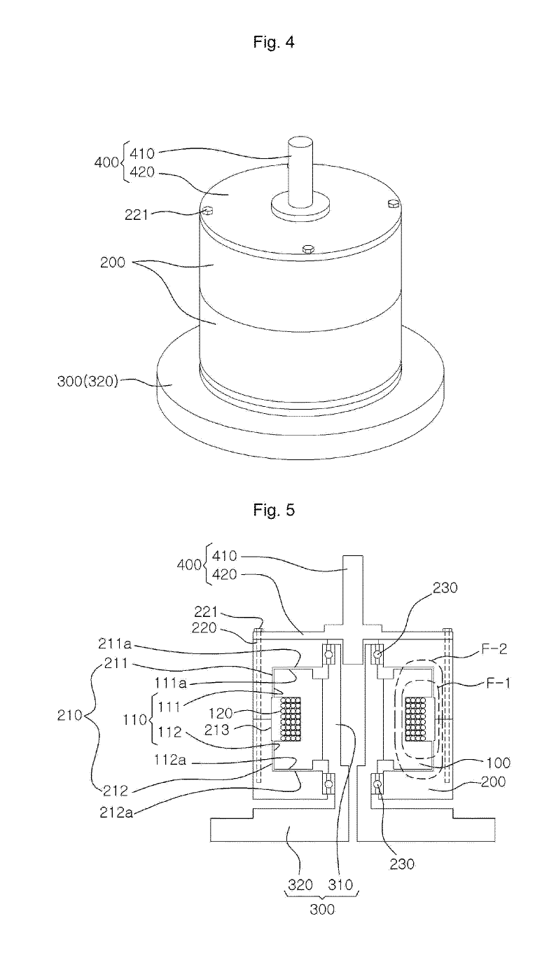

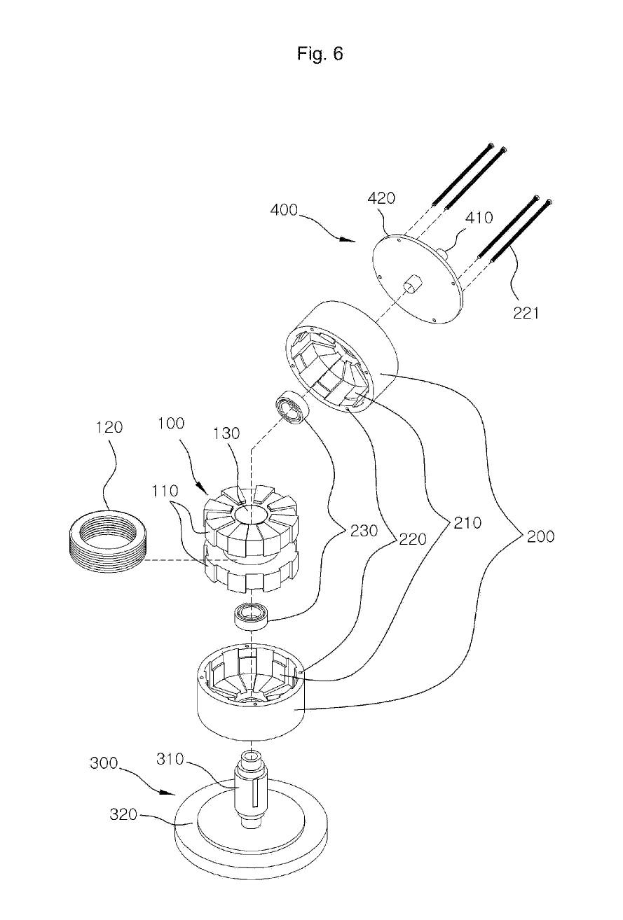

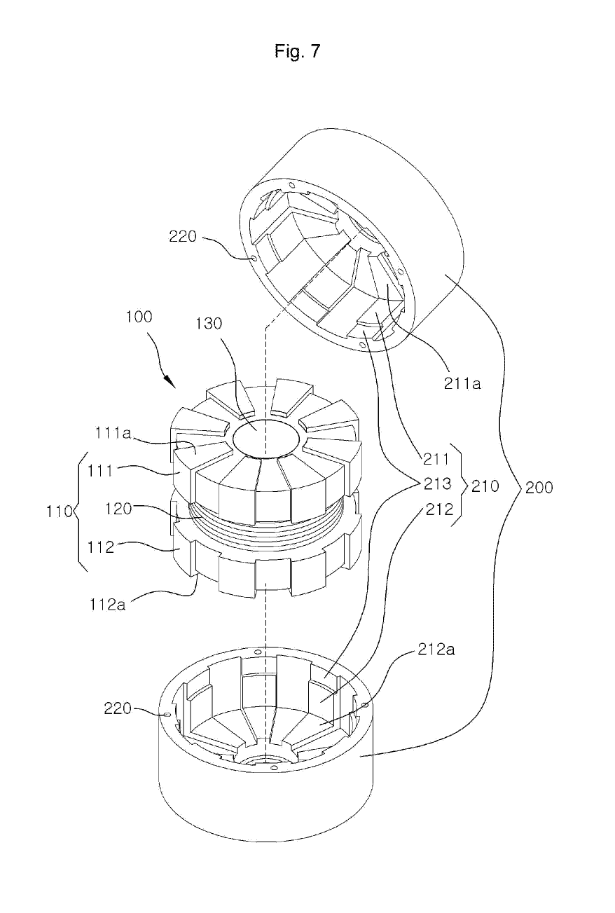

Referring to a perspective view of FIG. 4, a cross-sectional side view of FIG. 5, an exploded perspective view of FIG. 6, and an enlarged perspective view of the stator core 100 and the rotor core 200 of FIG. 7, the 3-D switched reluctance motor according to a first embodiment of the present invention includes the stator core 100, the rotor core 200, a stator mount member 300, and a rotor mount member 400.

The stator core 100 is in a cylindrical shape having a predetermined height and includes a coil 120 and a plurality of stator poles 110 in the outer circumferential surface thereof.

The coil 120 is wound around the outer circumferential surface of the stator core 100 along a circumferential direction by a predetermined number. The stator pole 110 comprises a pair of stator pole portions 111 and 112 vertically divided, allowing the coil 120 to pass between the pair of stator pole portions 111 and 112. The pair of stator pole portions 111 and 112 are disposed with equal spacing along a circumferential direction.

For example, the respective stator poles 110 disposed on the outer circumferential surface of the stator core 100 are separated into an upper stator pole portion 111 and a lower stator pole portion 112, and an excitation current flows through the coil 120 placed between the upper stator pole portion 111 and the lower stator pole portion 112, providing magnetic flux around the coil 120.

As such, a configuration of the transverse flux motor in which reluctance torque is generated by a transverse flux resulting from the stator pole 110 applies to a configuration of the outer circumferential surface of the stator core 100.

The stator core 100 includes a penetration passage 130 formed by vertically penetrating the stator core 100 at a rotation center, and an axis hub 310 of the stator mount member 300 is inserted into the penetration passage 130 and fixed.

According to a first embodiment of the present invention, respective stator poles 110, e.g., the upper stator pole portion 111 and the lower stator pole portion 112, disposed on the outer circumferential surface of the stator core 100 include portions 111a and 112a on an upper surface and a bottom surface of the stator core 100, respectively, to which the stator poles 110 are extended. In other words, the upper stator pole portion 111 disposed on the outer circumferential surface of the stator core 100 includes a portion 111a on the upper surface of the stator core 100 where the upper stator pole portion 111 is extended, and the lower stator pole portion 112 disposed on the outer circumferential surface of the stator core 100 includes a portion 112a on the bottom surface of the stator core 100 where the lower stator pole portion 112 is extended.

Such extended stator pole portions 111a and 112a provide an axial flux path F-2 to extended portions 211a and 212a of the rotor pole 210 and thus the axial flux path F-2 previously leaking through an axial direction of the transverse flux motor contributes to reluctance torque.

Extended stator pole portions 111a and 112a have a fan shape, the width of which is gradually narrower along a direction toward the penetration passage 130 located at a rotation center, and thus the extended stator pole portions 111a and 112a have the same phase as the stator pole 110 disposed on the outer circumferential surface of the stator core 100. As used herein, the term “same phase” means that extended stator pole portions 111a and 112a have a same arc angle as the stator pole 110 on the outer circumferential surface of the stator core 100. Specifically, lines connecting opposite end points of the stator pole 110 on the outer circumferential surface along a circumferential direction and a center of the penetration passage 130 form a boundary of the extended stator pole portions 111a and 112a.

Meanwhile, extended stator pole portions 111a and 112a may be formed to have an arc angle lower than an arc angle of the stator pole 110 disposed on the outer circumferential surface.

The stator mount member 300 includes the axis hub 310 protruding from a stator base 320. The axis hub 310 is fixedly inserted in the penetration passage 130 of the stator core 100 and located at a center of rotation.

Here, the stator base 320 is fixed in a position where the motor is installed and is not limited to a plate shape as shown in the drawings. It is satisfactory that the axis hub 310 is vertically fixed to the stator base 320, and the axis hub 310 is preferably formed of a nonmagnetic material. The axis hub 310 may be inserted in and fixed to the penetration passage 130 of the stator core 100 with a magnetic insulator installed in an outer circumferential surface of the axis hub 310.

The axis hub 310 is formed as a tube hollow shape and has a structure in which a bearing 230 is installed, respectively, at an upper end and a lower end of the outer circumferential surface of the axis hub 310, corresponding to the upper and lower portions of the stator core 100 that is fixedly inserted into the axis hub 310.

The rotor core 200 surrounds the stator core 100 with a gap therebetween and is rotatably coupled to the stator core 100 with respect to the rotation center of the stator core 100. The rotor core 200 includes a plurality of rotor poles 210 disposed with spacing on the inner circumferential surface of the rotor core 200 along a circumferential direction. The rotor pole 210 is configured to face the stator pole 110 to provide the transverse flux path to the stator pole 110 vertically divided into the upper and lower poles. Accordingly, upon exciting the stator pole 110 the transverse flux path generates reluctance torque and thus rotation force.

According to an embodiment of the present invention, the rotor core 200 is formed to surround, with an interval, the upper and bottom surfaces of the stator core 100 in which the extended stator pole portions 111a and 112a are formed. The rotor pole 210 is extended to portions 211a and 212a on the inner surface of the rotor core 200, facing the extended portions 111a and 112a of the stator pole 110 with an interval, thereby providing an axial flux path F-2.

Accordingly, the rotor core 200 surrounds the upper and lower surfaces as well as the outer circumferential surface of the stator core 100, and may have a structure in which an upper plate and a lower plate of the rotor core 200 having an opening at a rotation center are separately manufactured and then assembled with respect to a cylinder edge. Alternatively, the rotor core 200 may be manufactured as one solid body.

The upper portion 211 of the rotor pole 210 faces the upper portion 111 of the stator pole 110, and simultaneously the upper portion 211 of the rotor pole 210 is connected to the extended rotor pole portion 211a extending to a ceiling surface of the rotor core 200. The lower portion 212 of the rotor pole 210 faces the lower portion 112 of the stator pole 110, and simultaneously the lower portion 212 of the rotor pole 210 is connected to the extended rotor pole portion 212a extending to a bottom surface of the rotor core 200.

Like the stator core 100, extended rotor pole portions 211a and 212a have a fan shape to allow the extended rotor pole portions 211a and 212a to have the same phase as the rotor pole 210 on the inner circumferential surface of the rotor core 200. Here, extended rotor pole portions 211a and 212a may be formed to have an arc angle smaller than an arc angle of the rotor pole 210 disposed on the inner circumferential surface, while maintaining the arc angle of the extended rotor pole portions 211a and 212a within the arc angle of the rotor pole 210 on the inner circumferential surface.

Accordingly, reluctance torque by the transverse flux F-1 and reluctance torque by the axial flux F-2 are simultaneously generated. The transverse flux F-1 is generated between the rotor pole 210 disposed on the inner circumferential surface of the rotor core 200 and the stator pole 110 disposed on the outer circumferential surface of the rotor core 200, and the axial flux F-2 is generated between the extended rotor pole portions 211a and 212a disposed on the ceiling and bottom surfaces of the rotor core 200 and the extended stator pole portions 111a and 112a disposed on the upper and lower surfaces of the stator core 100.

According to a first embodiment of the present invention, the bearing 230 inserted into center openings of the upper plate and the lower plate of the rotor core 200 is seated in an upper bearing mount groove and a lower bearing mount groove, respectively, of the axis hub 310 so that the rotor core 200 is rotatably coupled to the stator core 100.

Further, a middle portion 213 of the rotor pole 210 positioned between the upper rotor pole portion 211 and the lower rotor pole portion 212 faces the coil 120 and has a concave portion having a smaller thickness than the upper rotor pole portion 211 or the lower rotor pole portion 212. Thus, the transverse flux is concentrated in the upper rotor pole portion 211 and the lower rotor pole portion 212.

According to an embodiment of the present invention, the rotor core 200 surrounds the outer circumferential surface, the upper surface and the lower surface of the stator core 100, except the portion of a rotation center, and thus the rotor core 200 may be conveniently manufactured into two pieces, e.g., the upper plate and the lower plate vertically divided at a position corresponding to the coil 120. The two plates can be integrally coupled using a bolt 221 fixedly inserted through coupling holes 220 sequentially penetrating the two plates.

However, the rotor core 200 is not limited to the structure in which the upper plate and the lower plate of the rotor core 200 are vertically divided, but manufactured in a different way. For example, the rotor core 200 may be manufactured in such a way that the rotor core 200 is perpendicularly divided at a rotation center position into left and right pieces. In this case, the left and right pieces are respectively manufactured and assembled to be folded while accommodating the stator core 100 between the left and right pieces. Upon assembling the left and right pieces into one body of the rotor core 200, a band wound around outer circumferential surfaces of the two pieces may be used, or a bolt penetrating a connection portion thereof may be used. It is also possible to perpendicularly divide the rotor core 200 into three pieces or more.

As shown in FIGS. 5 to 7, the extended rotor pole portions 211a and 212a are formed to be longer toward a center of rotation than the extended stator pole portions 111a and 112a, such that magnetic leakage is further reduced. For example, in addition to a surface where the extended rotor pole portions 211a and 212a face the extended stator pole portions 111a and 112a, the extended rotor pole portions 211a and 212a may be preferably formed to be wider than the extended stator pole portions 111a and 112a under a condition of maintaining the same phase.

The rotor mount member 400 is a component fastened the rotor core 200 to transfer rotation force due to reluctance torque generated at the rotor core 200 to an external body. According to an embodiment of the present invention, the rotor mount member 400 includes a disc-shaped rotor housing 420 and the disc-shaped rotor housing 420 including a shaft 410 at the center of rotation, upwardly protruding from the rotor housing 420, is fixedly fastened to the upper surface of the rotor core 200. The shaft 410 may be manufactured separately from the rotor housing 420 and assembled at a later time.

The shaft 410 upwardly protruding from the rotor housing 420 may be configured to downwardly protrude as well, such that the shaft 410 is inserted in the tube hollow of the axis hub 310 by a wide margin and stabilized during rotation.

According to a first embodiment of the present invention, the rotor core 200 is manufactured by assembling vertically divided pieces of the rotor core 200 using a bolt 221 inserted through coupling holes 220. The rotor core 200 may have a structure in which the rotor core 200 is vertically divided into an upper piece and a lower piece including, but not limited to, an upper plate and a lower plate, respectively. The bolt 221 may be inserted through the rotor housing 420 to the coupling holes 220 of the vertically divided pieces of the rotor core 200, thereby assembling the vertically divided pieces of the rotor core 200 and the rotor housing 420 simultaneously.

A technology for rotating a rotor core 200 by generating reluctance torque is a known technology and thus is not provided in the drawings, but the 3-D switched reluctance motor according to an embodiment of the present invention includes a position detection sensor sensing a rotation position of the rotor core 200 and a controller controlling a current flowing through the coil 120 depending on the rotation position of the rotor core 200. For example, referring to Korean Patent Publication No. 10-2016-0009774 published by the same applicants, reflecting boards disposed right under the respective rotor poles 210 on a one-to-one basis are installed below the rotor core 200, and a position detection sensor including a light emitting portion and a light receiving portion is placed on the upper surface of the stator base 320 in a position corresponding to a position where the reflecting board passes, thereby detecting a moment when the reflecting board passes due to rotation of the rotor core 200. Also, depending on the rotation position of the rotor core 200 obtained by detecting the reflecting board, the controller supplies current to the coil by using a dwell angle which is referred as to an angle approximately from a point where the rotor pole 210 and stator pole 110 are unaligned to another point where the rotor pole 210 and stator pole 110 are aligned. As such, the current periodically flowing through the coil according to the dwell angle periodically generates reluctance torque toward a direction to align the rotor pole 210 and stator pole 110 with each other, resulting in rotation of the rotor core 200.

As described above, according to a first embodiment of the present invention, the rotor core 200 surrounds the stator core 100 except a line position of a rotation center, and the stator pole 110 and the rotor pole 210 are three-dimensionally formed to utilize whole outer circumferential surfaces of the stator core 100 and whole inner circumferential surfaces of the rotor core 200.

Accordingly, the flux path three-dimensionally generated by an excitation current of the coil passes through the stator pole 110 and the rotor pole 210. The transverse flux and the axial flux three-dimensionally formed around the stator core 100 are used and transformed to rotational torque without leakage of electromagnetic force caused by an excitation current supplied at a dwell angle, thereby improving motor efficiency and output.

### A Second Embodiment

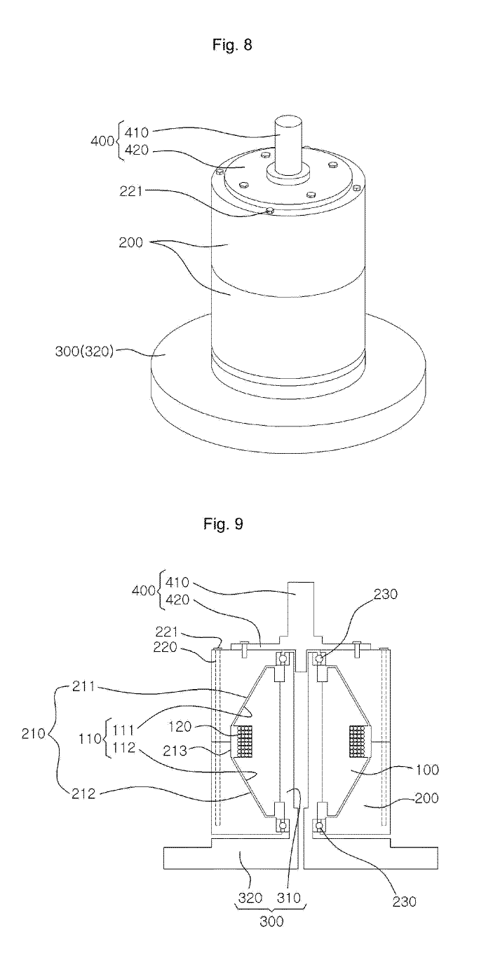

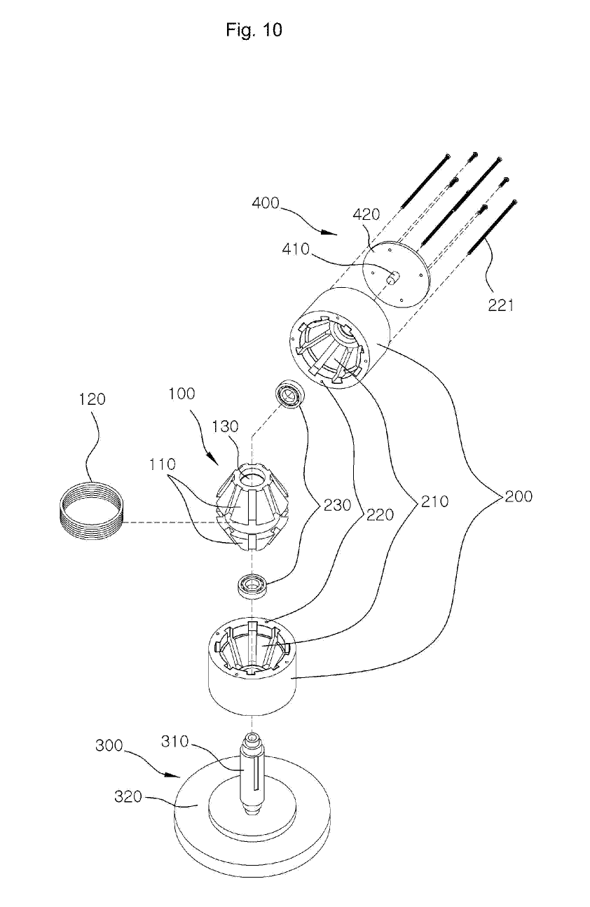

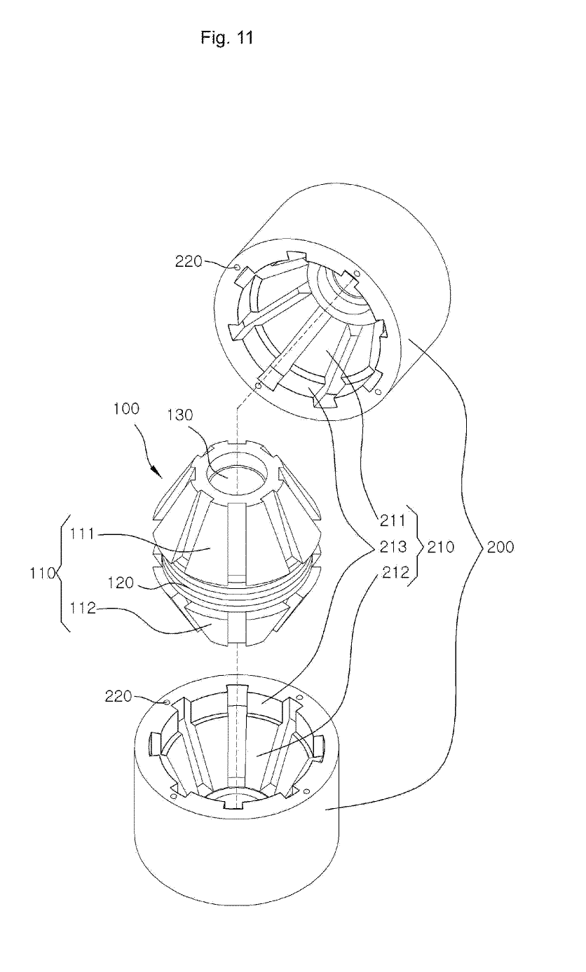

Referring to a perspective view of FIG. 8, a cross-sectional side view of FIG. 9, an exploded perspective view of FIG. 10, and an enlarged perspective view of the stator core 100 and the rotor core 200 of FIG. 11, the 3-D switched reluctance motor according to a second embodiment of the present invention has a difference in terms of the stator core 100 and the rotor core 200 from the first embodiment of the present invention.

Referring to FIGS. 8 to 11, the stator core 100 is tapered except a portion where the coil 120 is wound along a circumferential direction, having a cone shape in an upper portion, a short cylinder shape in a middle portion where the coil 120 is wound, and a reverse cone shape in a lower portion. The upper portion of the stator core 100 is upwardly tapered and the lower portion of the stator core 100 is downwardly tapered along an axial direction. The upper stator pole portion 111 disposed in the tapered upper portion and the lower stator pole portion 112 disposed in the reversely tapered lower portion are formed to be symmetrical to each other, such that the stator pole 110 is divided into the upper and lower pole portions.

Here, the upper stator pole portion 111 has a narrower width upwardly, e.g., upon approaching toward a rotation center along an inclined surface, and similarly the lower stator pole portion 112 has a narrower width downwardly, e.g., upon approaching toward a rotation center along an inclined surface, thereby allowing the upper and lower stator pole portions 111 and 112 to be in the same phase as the phase of the stator pole 110 disposed on the circumferential surface of the stator core 100. Accordingly, each section of the stator pole portions has the same arc angle with respect to a rotation center.

The inner surface of the rotor core 200 surrounds the outer circumferential surface of the stator core 100 with a gap therebetween. The gap is larger than the air gap between the stator pole 110 and the rotor pole 210 and is an interval increasing magnetic resistance, and thus it may be negligible upon considering a flux path.

The inner surface of the rotor core 200 is provided with a rotor pole 210 facing the stator pole 110 with a constant gap between the rotor pole 210 and the stator pole 110.

The rotor pole 210 includes an upper rotor pole portion 211 facing the upper stator pole portion 111 and a lower rotor pole portion 212 facing the stator pole lower portion 112. Here, a middle portion 213 between the upper rotor pole portion 211 and the lower rotor pole portion 212 faces the coil 120 wound around the stator core 100, and as described in the first embodiment of the present invention, the middle portion 213 may be formed to be concave with respect to the upper and lower portions.

Between the stator pole 110 and the rotor pole 210 configured as described above, there exists a flux that may be considered a medium state of the transverse flux and the axial flux. Accordingly, although a density of magnetic flux decreases as moving away from the coil 120, the flux contributes to reluctance torque, not leaking.

In the meantime, the rotor core 200 illustrated in FIGS. 8 to 11 has an externally cylindrical shape, but a radial thickness of the upper inside and the lower inside of the rotor core 200 on which the rotor pole 210 is disposed is formed to be thicker than a radial thickness of the middle portion of the rotor core 200, thereby functioning as a flywheel. However, the upper and the lower portion of the rotor core 200 may be formed to be externally tapered to reduce a weight of the rotor core 200.

According to the first and second embodiments of the present invention, the 3-D switched reluctance motor is a single-phase switched reluctance motor, when a plurality of the stator poles 110 and a plurality of the rotor poles 210 are disposed with an equal angle along a circumferential direction and aligned on a one-to-one correspondence basis.

The 3-D switched reluctance motor is configured to be a single phase motor according to an embodiment of the present invention. Third and fourth embodiments of the present invention having a multi-phase motor rotating a shaft using a plurality of single phase motors is described below.

### A Third Embodiment

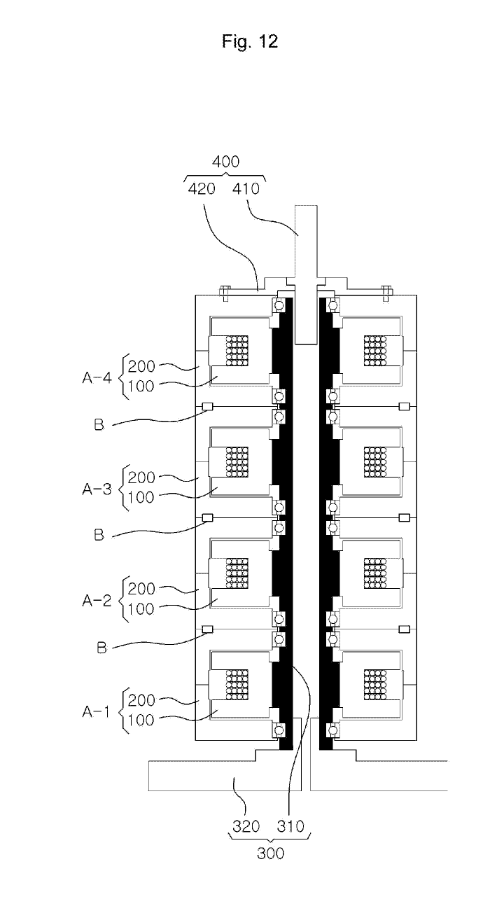

As shown in FIG. 12, according to a multi-phase 3-D switched reluctance motor, a plurality of unit modules A-1, A-2, A-3, and A-4 are sequentially stacked, such that the stator cores 100 of the unit modules are penetrated by one axis hub 310 and fixed to the axis hub 310. Herein, the “unit module” refers to a motor unit including one stator core 100 and one rotor core 200.

A rotor core 200 of each unit module is rotatably coupled to the axis hub 310 by using a bearing and then stacked. The unit modules are vertically connected and fixed to each other by a connecting means B so that the unit modules rotate as one rotating body. The connecting means B may be configured to fasten, e.g., upper and lower notches together which are formed on contact surfaces of unit modules, e.g., on a bottom surface of a unit module placed above and a top surface of a unit module placed below when the two unit modules are coupled to each other.

Further, a rotor mount member 400 including a shaft 410 is fastened to the uppermost unit module A-4 and transfers rotation force generated by the rotor core 200 of the respective unit modules rotating like one rotating body to the shaft 410.

Also, a rotation angle θ of the rotor pole 210 with respect to the stator pole 110 is set to be different between the unit modules, while keeping their difference constant, to configure a multi-phase motor.

The motor comprising a N-number of the unit module including a rotor core 200 having a P-number of a rotor pole 210 is described below.

A rotation angle θ of the rotor pole 210 with respect to the stator pole 110 refers to a difference in an angle between a rotation position of the rotor pole 210 trying to be aligned with the stator pole 110 depending on rotation of the rotor core 200 and a position of the stator pole 110.

The rotation angle θ of the rotor pole 210 at each unit module is one of values calculated by Equation (1) when the rotation angle θ is represented by a mechanical angle, and different rotation angles θ are allocated to the respective unit modules.

$$θ = \frac{2 π}{PN} i , i = 0 , 1 , 2 , … , N - 1 \qquad ( 1 )$$

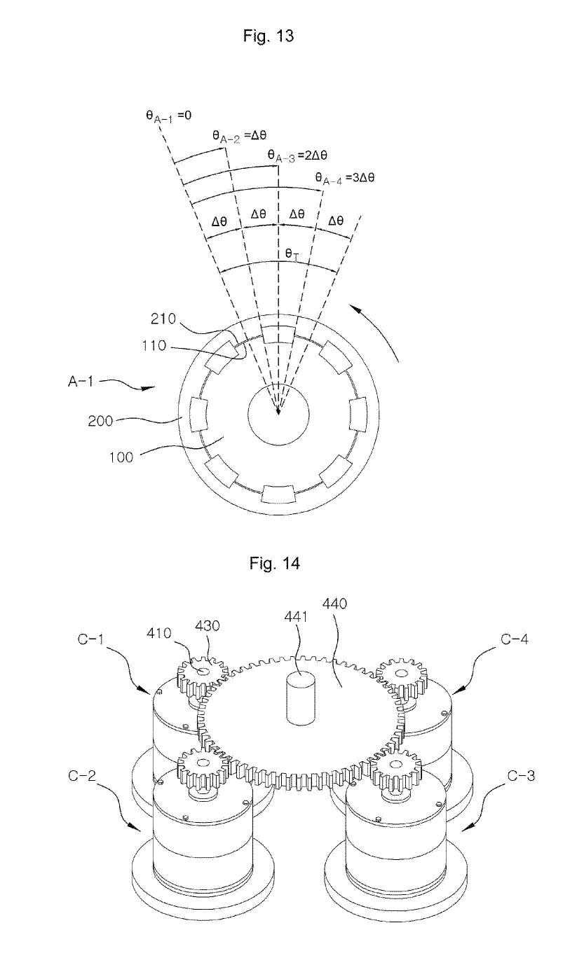

FIG. 13 is a view illustrating the rotation angle of the rotor pole 210 displayed on a cross-sectional top view of the lowermost unit module A-1, in which P equals 8 and N equals 4.

In this case, according to Equation (1), four points having

$$Δθ = \frac{2 π}{8 * 4}$$

of difference in the rotation angle θ are determined. As shown in FIG. 13, under an assumption that the rotor pole 210 is aligned to the stator pole 110 at the lowermost unit module A-1, the rotation angle is distributed in accordance with a stacking order and the rotation angles of

$${θ}_{A - 1} = 0 , {θ}_{A - 2} = \frac{2 π}{8 * 4} , {θ}_{A - 3} = \frac{2 π}{8 * 4} * 2 , and {θ}_{A - 4} = \frac{2 π}{8 * 4} * 3$$

are distributed to realize a four-phase motor.

Upon assembling four unit modules, the stator poles of the respective unit modules are vertically aligned to be positioned within a same straight line and the rotor cores 200 are sequentially stacked and fixed to each other so that the rotation angle between two vertically adjacent rotor poles is set to be different by

$$Δθ = \frac{2 π}{8 * 4} .$$

In another way to assemble unit modules, upon fastening the stator core 100 to the axis hub 310, the stator poles of the respective unit modules are sequentially fixed, so that the rotation angle between two vertically adjacent stator poles is set to be different by

$$Δθ = \frac{2 π}{8 * 4} ,$$

while the rotor poles of the respective unit modules are vertically aligned to be positioned within a same straight line.

Since a difference T in the rotational angle θ between circumferentially adjacent rotor poles 210 refers to a 1 period, a rotation position of the rotor pole 210 may be represented by an electrical angle. As such, the number of the rotor pole, e.g., N, is multiplied to express Equation (1) using the electrical angle, thereby inducing Equation (2).

$$θ = \frac{2 π}{N} i , i = 0 , 1 , 2 , … , N - 1 \qquad ( 2 )$$

In summary, a rotation phase of the unit module refers to a rotation position of the rotor pole 210 according to a position of the stator pole 110, represented by the electric angle. Accordingly, the rotation phase of the unit module is set to have a phase difference of

$$\frac{2 π}{N}$$

to make a N-phase motor.

For example, when a N-number of the unit module is stacked, the unit module may be stacked to have a leading phase angle of

$$\frac{2 π}{N} ,$$

or a lagging phase angle of

$$\frac{2 π}{N} ,$$

as compared to a phase angle of a previously stacked unit module.

### A Fourth Embodiment

FIG. 14 is a perspective view illustrating a multi-phase 3-D switched reluctance motor configured to include a plurality of 3-D switched reluctance motors assembled in parallel.

Referring to FIG. 14, a plurality of 3-D switched reluctance motors C-1, C-2, C-3, and C-4 include driving gears 430 comprising a spur gear. The driving gears 430 are coupled to the shaft 410 and disposed at a position close to a driven gear 440 comprising a spur gear, such that that respective driving gears 430 engage with the driven gear 440. Accordingly, the respective 3-D switched reluctance motors C-1, C-2, C-3, and C-4 exert rotation force to the driven gear 440, allowing the driven gear 440 to transmit the rotation force to an external body through a driven gear shaft 441.

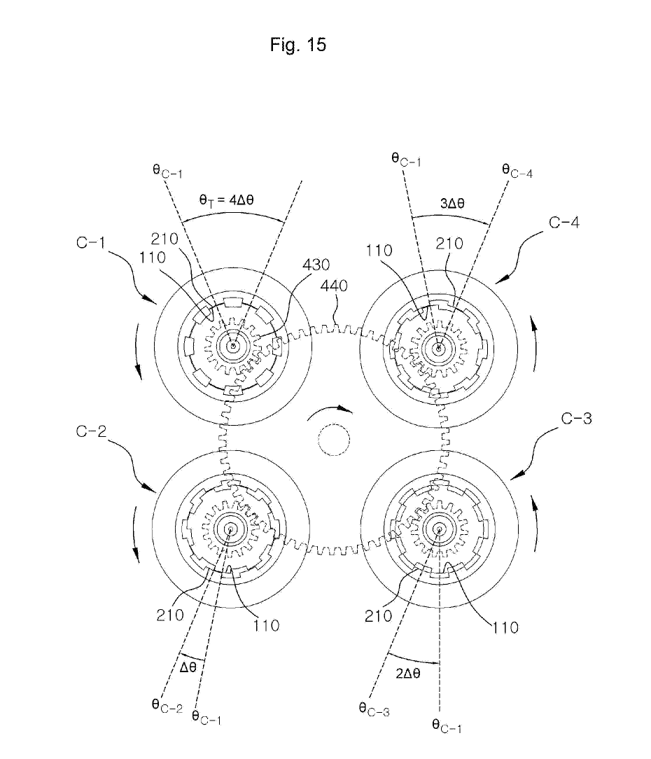

Also, as show in FIG. 15, a rotation position of the rotor core 200 of the respective 3-D switched reluctance motor C-1, C-2, C-3, and C-4 may be represented by a mechanical angle of Equation (1) or an electric angle (or a phase difference) of Equation (2). In FIG. 15, four 3-D switched reluctance motors C-1, C-2, C-3, and C-4 disposed along a circumferential direction of the driven gear 440 are configured to sequentially have a lagging phase difference in a counter clockwise order.

As such, the unit modules are assembled in a serial form described in connection with the third embodiment of the present invention, or in a parallel form described in connection with the fourth embodiment of the present invention to realize the multi-phase 3-D switched reluctance motor, such that the motor output is enhanced and a torque ripple and noise are reduced as compared with a motor in which a single-phase is configured.

### A Fifth Embodiment

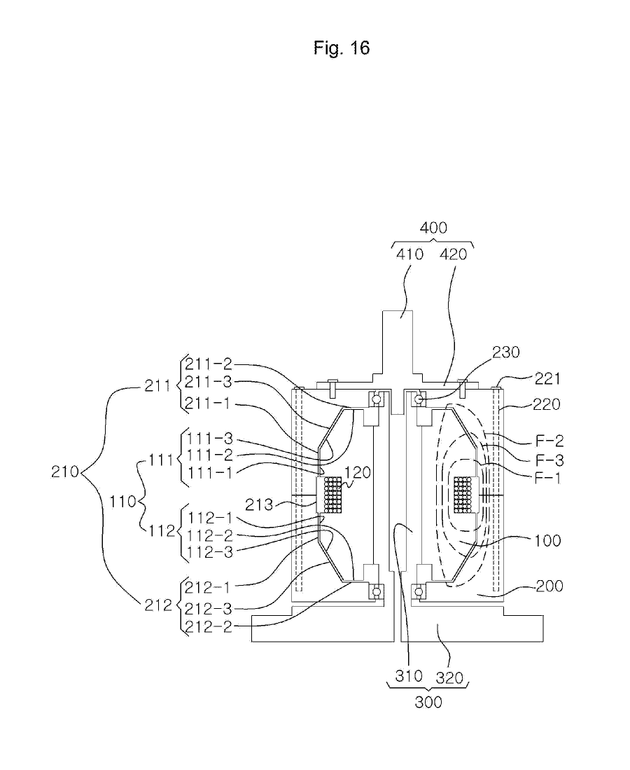

FIG. 16 is a cross-sectional side view illustrating a 3-D switched reluctance motor including features of the first and second embodiments of the present invention, and a difference will be described in detail.

The stator core 100 is formed to be vertically tapered, as seen in the second embodiment of the present invention, except a portion of an outer circumferential surface close to the coil 120 wound around the stator core 100 at a medium height position of the outer circumferential surface along a circumferential direction and a portion of an upper surface and a bottom surface close to a rotation axis (i.e., near the penetration passage 130). In other words, the stator core 100 is formed so that upper and lower edges thereof are inclined to have a chamfer shape and the coil 120 is wound around a remaining medium portion of the outer circumferential surface.

The stator pole 110 includes an upper stator pole portion 111 in which a portion 111-1 protruding from a remaining outer circumferential surface above the coil 120, a portion 111-3 protruding from an upper inclined surface that is tapered, and a portion 111-2 protruding from a remaining upper surface are consecutively connected, and a lower stator pole portion 112 in which a portion 112-1 protruding from a remaining outer circumferential surface below the coil 120, a portion 112-3 protruding from a lower inclined surface that is tapered, and a portion 112-2 protruding from a remaining bottom surface are consecutively connected.

The rotor core 200 is formed to surround the outer circumferential surface, the tapered surfaces, the upper surface, and the bottom surface of the rotor core 200 with a predetermined interval therebetween.

The rotor pole 210 is disposed with equal spacing on the inner surface of the rotor core 200 along a circumferential direction, such that the rotor pole 210 faces the stator pole 110. The rotor pole 210 includes an upper rotor pole portion 211 (211-1, 211-2, and 211-3) bent along the bent surfaces of the upper stator pole portion 111 (111-1, 111-2, and 111-3) to maintain an air gap constant through the whole upper stator pole portions 111, a middle position 213 facing the coil 120, and a lower rotor pole portion 212 (212-1, 212-2, and 212-3) that is bent along the bent surfaces of the lower stator pole portion 112 (112-1, 112-2, and 112-3) to maintain an air gap constant through the whole lower stator pole portions 112.

As such, the rotor pole 210 provides an additional flux path F-3 toward an upwardly inclined direction and a downwardly inclined direction, in addition to the transverse flux path F-1 and the axial flux path F-2 as seen in the first embodiment of the present invention. Here, the flux path F-3 toward inclined directions has an effect of reducing a length of the flux path, thereby reducing magnetic flux leakage occurring inside the core.

Meantime, when the stator pole 110 and the rotor pole 210 facing each other with a constant air gap therebetween are perpendicularly sectioned along an axial direction at a center of rotation, the cross section has a shape in which the upper and lower portions of the stator pole 110 and the rotor pole 210 are bent twice, respectively. However, the present invention is not limited thereto and may be modified to be bent more than twice. For example, upon making the stator pole 110 and the rotor pole 210 to be tapered, the poles 110 and 210 may be tapered in two stages connected to each other, but inclination angles thereof may be set to be different from each other.

### A Sixth Embodiment

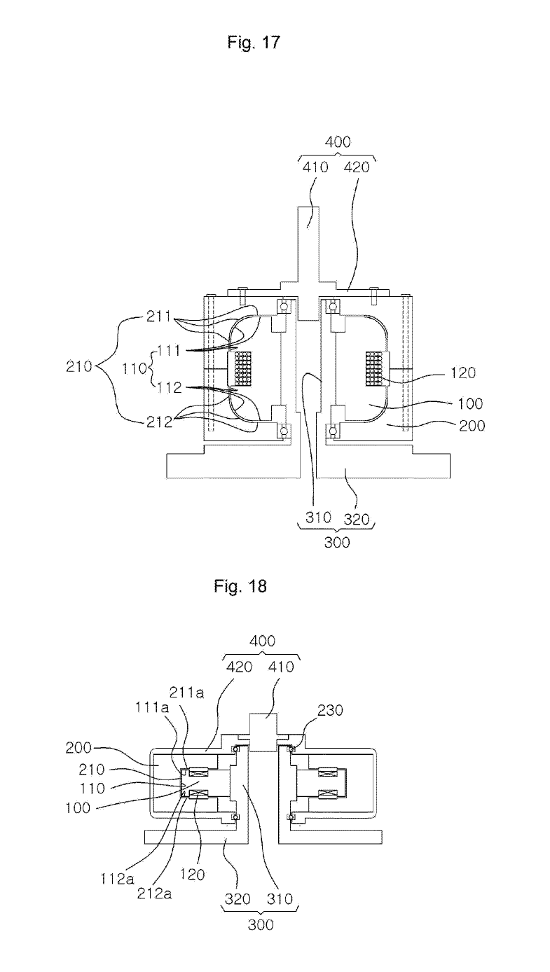

The sixth embodiment as shown in FIG. 17 is an alteration of the fifth embodiment illustrated in FIG. 16, and has a configuration of curved lines instead of tapered surfaces having a constant inclination angle.

In the 3-D switched reluctance motor according to an embodiment of the present invention, when the stator pole 110 and the rotor pole 210 facing each other with a constant air gap therebetween are sectioned at a center of rotation along an axial direction, the cross section may include curved lines in a portion.

The stator pole 110 may be formed to be curved through whole portions, e.g., from a portion close to the coil 120 to a portion where the stator core 100 is fixed to the axis hub 310. In this care, the rotor pole 210 is formed curved in whole portions.

### A Seventh Embodiment

FIG. 18 is a cross-sectional side view illustrating the 3-D switched reluctance motor applied to and configured for a radial air gap motor.

In a typical radial air gap motor type of switched reluctance motor, the coil 120 is separately wound around the respective stator pole 110 arranged in an equal angle along the circumferential direction of the stator core 100 so that a flux path is generated through an air gap of a radial direction. Further, the rotor pole 210 is arranged in an equal angle on the inner circumferential surface of the rotor core 200 such that the rotor pole 210 faces the stator pole 110. Accordingly, a flux path passing through the radial air gap between the stator pole 110 and the rotor pole 210 is generated. The flux path forms a closed path through the inside of the rotor core, the inside of the stator core, and adjacent other stator and rotor poles.

According to an embodiment of the present invention, upon being applied to the radial air gap motor, the rotor core 200 is formed to surround an upper surface and a lower surface of the stator core 100. The stator pole 110 includes extended stator pole portions 111a and 112a extending to the upper surface and the bottom surface of the stator core 100 and the rotor pole 210 includes extended rotor pole portions 211a and 212a extending to an inner ceiling surface and a bottom surface of the rotor core 200. In this case, the extended pole portions are preferably configured to have the same phase as the pole portions prior to extending.

However, since the respective stator pole 110 protrudes in a radial direction from the outer circumferential surface of the stator core 100, a surface of a circumferential direction (a surface facing the adjacent stator core in a circumferential direction) is not surrounded by the rotor core 200 and thus the rotor core 200 is not prevented from rotating.

In other words, the rotor core 200 according to an embodiment of the present invention surrounds the stator pole 110 while not affecting rotation of the rotor core 200.

The extended stator pole portions 111a and 112a include a pair of pole portions divided into an inner pole portion and an outer pole portion with respect to a position where the coil 120 is wound, and the extended rotor pole portions 211a and 212a are configured to provide a flux path between the pair of pole portions. As seen in the rotor pole of the transverse flux motor, the rotor pole 210 provides the flux path between the pair of pole portions constituting the stator pole 110.

Accordingly, such extended portions enable magnetic flux previously leaking through the upper portion and the lower portion of the stator core 100 to contribute to reluctance torque.

### An Eighth Embodiment

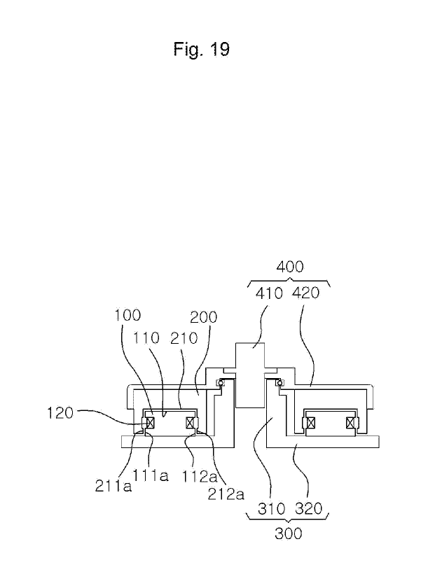

FIG. 19 is a cross-sectional side view illustrating the 3-D switched reluctance motor applied to and configured for an axial air gap motor.

A typical axial air gap motor type of switched reluctance motor includes a stator core 100 of a disc shape in which a fan-shaped stator pole 110 is disposed on an upper surface of the stator core 100 along a circumferential direction, and a rotor core 200 of a disc shape in which a fan-shaped rotor pole 210 is disposed on an inner ceiling surface of the rotor core 200 along a circumferential direction. In general, the stator core 100 is disposed above the rotor core 200 such that the stator pole 110 faces the rotor pole 210 with an air gap therebetween. The coil 120 separately provided in the respective stator pole 110 is wound around a side surface of the stator pole 110 and surrounds the stator pole 110.

An axial flux is generated at the respective stator pole 110 and the axial flux forms a closed path through the inside of the rotor core, the inside of the stator core, and adjacent other stator and rotor poles.

According to an exemplary embodiment of the present invention, upon being applied to axial air gap motor, the rotor core 200 is formed to surround an outer circumferential surface and an inner circumferential surface of the stator core 100. The stator pole 110 includes extended stator pole portions 111a and 112a extending to the outer and inner circumferential surfaces of the stator core 100, and the rotor pole 210 includes extended rotor pole portions 211a and 212a extending to the outer and inner circumferential surfaces of the stator core 100. As seen in the first embodiment of the present invention, the extended pole portions may preferably have the same phase as the poles prior to extending.

Accordingly, such extended portions enable magnetic flux previously leaking through a direction of the outer circumferential surface and the inner circumferential surface to contribute to reluctance torque.

Meanwhile, the respective extended stator pole portions 111a and 112a are preferably configured to include a pair of extended stator pole portions divided into an upper pole portion and a lower pole portion with respect to the coil 120 wound around a side surface of the stator core 100 along a circumferential direction. The extended rotor pole portions 211a and 212a are preferably formed to face the pair of the stator pole portions simultaneously, thereby providing a flux path passing therethrough like a transverse flux path.

Here, the rotor core 200 does not surround a circumferential surface of the stator pole 110 and rotation of the rotor core 200 is not affected.

Upon manufacturing the axial air gap motor type of switched reluctance motor, a circumferential length of the stator pole 110 at a position close to a center of rotation is shorter than a circumferential length thereof at an opposite position, e.g., a position close to the outer circumferential surface. Thus, the rotor core 200 may be formed to surround the outer circumferential surface of the stator pole 110 instead of the inner circumferential surface and the stator pole 110 may be extended to the outer circumferential surface of the stator pole 110.

According to an exemplary embodiment of the present invention, the stator pole 110 is three-dimensionally provided in the stator core 100 to utilize magnetic flux three-dimensionally formed by the stator pole 110 without leakage. In a similar manner, the rotor pole 210 is three-dimensionally provided in the rotor core 200. Accordingly, the stator core 100 including the stator pole 110 and the rotor core 200 including the rotor pole 210 are preferably formed of a compressed powder core in which a mixed power of soft magnetism pure iron and silicon steel is compressed and formed. Alternatively, a thin metal pin (e.g., a silicon steel plate) may be piled to manufacture a core for a flux path (or a magnetic path).

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

### DESCRIPTION OF NUMERALS IN DRAWINGS

100: stator core
110: stator pole
111: upper stator pole portion
112: lower stator pole portion
111a, 112a: extended stator pole portions
120: coil
130: penetration passage
200: rotor core
210: rotor pole
211: upper rotor pole portion
212: lower rotor pole portion
211a, 212a: extended rotor pole portions
220: coupling hole
221: bolt
230: bearing
300: stator mount member
310: axis hub
320: stator base
400: rotor mount member
410: shaft
420: rotor housing
430: driving gear
440: driven gear
441: driven gear shaft

What is claimed is:

1. A three-dimensional (3-D) switched reluctance motor, comprising:
a stator core 100 generating one of a radial magnetic flux, an axial magnetic flux, and a transverse magnetic flux generated toward a stator pole 110 excited by a coil 120; and
a rotor core 200 rotatably coupled to the stator core 100, including a rotor pole 210 facing the stator pole 110 with an air gap therebetween, and rotating by reluctance torque, wherein
the rotor core 200 three-dimensionally surrounds an outer portion of the stator core 100 including a portion where magnetic leakage occurs, while not affecting rotation of the rotor core 200, and the stator pole 110 and rotor pole 210 are three-dimensionally formed to extend to the portion, and magnetic flux passing through the extended portions of the stator pole 110 and rotor pole 210 contributes to reluctance torque.

2. The 3-D switched reluctance motor of claim 1, wherein the extended portions of the stator pole 110 and the rotor pole 210 have an arc angle within a range of an arc angle of the stator pole 110 and the rotor pole 210 before extending, and the extended portions of the stator pole 110 and rotor pole 210 are in a same phase.

3. The 3-D switched reluctance motor of claim 1, wherein the stator core 100 includes the stator pole 110 disposed on the outer circumferential surface of the stator core 100, and the stator pole 110 disposed on the outer circumferential surface vertically divided into an upper portion and a lower portion with respect to the coil 120 wound around the outer circumferential surface along a circumferential direction extends to an upper surface and a lower surface of the stator core 100, and wherein the rotor core 200 includes the rotor pole 210 on the inner circumferential surface of the rotor core 200, and the rotor pole 210 disposed on the inner circumferential surface faces the stator core 110 in a radial direction to provide a transverse flux path to the stator pole 110 vertically divided and extends to an inner ceiling surface and a bottom surface of the rotor core 200, thereby providing an axial flux path to the stator pole 110 extended thereto.

4. The 3-D switched reluctance motor of claim 2, wherein the stator core 100 includes the stator pole 110 disposed on the outer circumferential surface of the stator core 100, and the stator pole 110 disposed on the outer circumferential surface vertically divided into an upper portion and a lower portion with respect to the coil 120 wound around the outer circumferential surface along a circumferential direction extends to an upper surface and a lower surface of the stator core 100, and wherein the rotor core 200 includes the rotor pole 210 on the inner circumferential surface of the rotor core 200, and the rotor pole 210 disposed on the inner circumferential surface faces the stator core 110 in a radial direction to provide a transverse flux path to the stator pole 110 vertically divided and extends to an inner ceiling surface and a bottom surface of the rotor core 200, thereby providing an axial flux path to the stator pole 110 extended thereto.

5. The 3-D switched reluctance motor of claim 3, wherein an upper portion of the stator core 100 is upwardly tapered and a lower portion of the stator core 100 is downwardly tapered along an axial direction with respect to a portion where the coil 120 is wound, wherein the stator pole formed on the upper tapered surface has a symmetric shape with the stator pole formed on the lower tapered surface, wherein the stator pole formed on the upper tapered surface has a narrower width upwardly and the stator pole formed on the lower tapered surface has a narrower width downwardly, and wherein the rotor pole 210 disposed on the inner surface of the rotor core 200 is inclined according to the tapered shape of the stator pole to face the tapered stator pole with a constant air gap therebetween.

6. The 3-D switched reluctance motor of claim 1, wherein the rotor core 200 is formed by coupling vertically divided pieces obtained by vertically sectioning the rotor core 200 along a circumferential direction, or by coupling divided pieces obtained by perpendicularly sectioning the rotor core 200.

7. The 3-D switched reluctance motor of claim 2, wherein the rotor core 200 is formed by coupling vertically divided pieces obtained by vertically sectioning the rotor core 200 along a circumferential direction, or by coupling divided pieces obtained by perpendicularly sectioning the rotor core 200.

8. The 3-D switched reluctance motor of claim 1, wherein a unit module is formed by coupling one rotor core 200 and one stator core 100, wherein a N-number of a unit module is stacked, wherein a stator core of the N-number of a unit module is fixed to one axis hub, and wherein a rotor core of the N-number of a unit module is connected to each other to make one rotating body, thereby configuring a N-phase switched reluctance motor having a rotation phase difference of
$$\frac{2 π}{N}$$
between the unit modules.

9. The 3-D switched reluctance motor of claim 2, wherein a unit module is formed by coupling one rotor core 200 and one stator core 100, wherein a N-number of a unit module is stacked, wherein a stator core of the N-number of a unit module is fixed to one axis hub, and wherein a rotor core of the N-number of a unit module is connected to each other to make one rotating body, thereby configuring a N-phase switched reluctance motor having a rotation phase difference of
$$\frac{2 π}{N}$$
between the unit modules.

10. The 3-D switched reluctance motor of claim 1, wherein a plurality of 3-D switched reluctance motors are disposed along a circumferential direction of a driven gear 440, wherein the plurality of 3-D switched reluctance motors respectively transfer rotation force to the driven gear 440, and wherein the rotor cores of the plurality of 3-D switched reluctance motors have a rotation phase difference of
$$\frac{2 π}{N}$$
between two adjacent ones of the rotor cores, thereby configuring a N-phase switched reluctance motor.

11. The 3-D switched reluctance motor of claim 2, wherein a plurality of 3-D switched reluctance motors are disposed along a circumferential direction of a driven gear 440, wherein the plurality of 3-D switched reluctance motors respectively transfer rotation force to the driven gear 440, and wherein the rotor cores of the plurality of 3-D switched reluctance motors have a rotation phase difference of
$$\frac{2 π}{N}$$
between two adjacent ones of the rotor cores, thereby configuring a N-phase switched reluctance motor.

12. The 3-D switched reluctance motor of claim 1, wherein a cross-sectional shape of the stator pole 110 and the rotor pole 210 has multiple bent portions when the stator pole 110 and the rotor pole 210 are perpendicularly sectioned in an axial direction, and the air gap between the stator pole and the rotor pole has a constant thickness in a whole section.

13. The 3-D switched reluctance motor of claim 2, wherein a cross-sectional shape of the stator pole 110 and the rotor pole 210 has multiple bent portions when the stator pole 110 and the rotor pole 210 are perpendicularly sectioned in an axial direction, and the air gap between the stator pole and the rotor pole has a constant thickness in a whole section.

14. The 3-D switched reluctance motor of claim 1, wherein a cross-sectional shape of the stator pole 110 and the rotor pole 210 has a curved line in a portion of or a whole section when the stator pole 110 and the rotor pole 210 are perpendicularly sectioned in an axial direction, and the air gap between the stator pole and the rotor pole has a constant thickness in each section.

15. The 3-D switched reluctance motor of claim 2, wherein a cross-sectional shape of the stator pole 110 and the rotor pole 210 has a curved line in a portion of or a whole section when the stator pole 110 and the rotor pole 210 are perpendicularly sectioned in an axial direction, and the air gap between the stator pole and the rotor pole has a constant thickness in each section.
